(19) United States
(12) Patent Application Publication
(10) Pub. No.: US 2008/0244640 A1
(43) Pub. Date: Oct. 2, 2008

(54) SYNCHRONIZATION OF DIGITAL TELEVISION PROGRAMS WITH INTERNET WEB APPLICATION

(75) Inventor: Loys Belleguie, Tokyo (JP)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/691,652

(22) Filed: Mar. 27, 2007

(51) Int. Cl. H04N 7/08

(52) U.S. Cl. 725/35; 348/510; 725/32; 725/34

(57) ABSTRACT

An architecture is presented that synchronizes digital television content with IP network content. A content management system is provided that comprises a computing system that includes an input component and an application component. The input component of the computing system receives digital television content of a broadcast network. The application component receives IP network content of an IP network. The application component then synchronizes the IP network content and the digital television content via DSM-CC stream events. The DSM-CC stream events are markers that comprise an event identifier and a time reference. Based on the event identifier and the time reference, the broadcasted digital television content can be synchronized with the IP network content to deliver additional content media and commercials tailored to specific groups of viewers based on demographics, geography and/or individual profiles.

### BACKGROUND

In recent years, convergence between over-the-air broadcast digital television and video delivery over Internet Protocol (IP) channel has given rise to the need of developing fully synchronized applications receiving or transmitting data from or to, both channels.

Moreover, the distribution of television programs on the Internet is limited by the lack of technical solutions to develop business models which can leverage conventional broadcasting. Furthermore, some sponsors are reluctant to advertise on the Internet due to the lack of control over who views the content and how often. To complicate matters, there is no real concept of media time with broadcasted digital television services. Since one can join the stream at any point, there is no way of knowing how long it is since the stream started.

Accordingly, the convergence of broadcast and IP delivery channels has been an area of intense development in the past years. However, current solutions are not widely implemented in reality and lack available compliant platforms and market acceptance.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a content management system that comprises a computing system that includes an input component and an application component. The input component of the computing system receives digital television content of a broadcast network. The application component receives internet protocol (IP) network content of an IP network. The application component then synchronizes the IP network content and the digital television content. The synchronized IP content and digital television content is then utilized to deliver additional content media and commercials tailored to specific groups of viewers based on demographics, geography and/or individual profiles.

Further, the application component utilizes digital storage media command and control (DSM-CC) stream events to synchronize the IP network content and the digital television content. The DSM-CC stream events are markers that are embedded in a transport stream via MPEG-2 private sections. Each marker comprises an event identifier and a time reference. The event identifier allows each stream event to be uniquely identified, the stream events are content media programs, and the time reference indicates at what point in the stream the event should be triggered. Based on the event identifiers and the time reference, the broadcasted digital television content can be synchronized with the IP network content.

In another aspect of the claimed subject matter, the stream events are used to assign firing at several times in the future. For example, several timing references can be defined with a single DSM-CC event ID. This allows the sender to create multiple firing times referring to the same original broadcast event. Thus, the event identifier allows each stream event to be uniquely identified, and the time reference indicates at what point or points in the stream the event should be triggered. Accordingly, broadcasters are allowed to schedule events on the viewer platform in advance.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a block diagram of a content management system.

FIG. 2 illustrates a block diagram of the content management system wherein an application component utilizes DSM-CC for synchronizing content.

FIG. 3 illustrates a block diagram of the DSM-CC of the content management system.

FIG. 4 illustrates a block diagram of operation of the content management system.

FIG. 5 illustrates a block diagram of a synchronization mechanism of the content management system.

FIG. 6 illustrates a flow chart of a method of synchronizing digital television content with IP network content.

FIG. 7 illustrates a flow chart of a method of launching a specific process in relation with broadcasted commercial content.

FIG. 8 illustrates a flow chart of a method of launching additional documentary applications in relation with news show content.

FIG. 9 illustrates a flow chart of a method of launching additional sports events applications in relation with the sports show content.

FIG. 10 illustrates a flow chart of a method of allowing a broadcaster to schedule events on a viewer platform in advance.

FIG. 11 illustrates a block diagram of a computer operable to execute the disclosed synchronization architecture.

FIG. 12 illustrates a schematic block diagram of an exemplary computing environment for use with the content management system.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component,” “handler,” “model,” “system,” and the like are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Additionally, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer-readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the claimed subject matter.

As used herein, terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In recent years, convergence between over-the-air broadcast digital television and video delivery over Internet Protocol (IP) channel has given rise to the need of developing fully synchronized applications receiving or transmitting data from or to, both channels. Convergence between digital television broadcasts and the IP channel is needed to create a proper mechanism to ensure reliable and robust synchronization of digital television streams and an application running on a personal computer (PC) and receiving contents from the Internet that is correlated with the broadcast programs. The contents on both channels can be video, audio or any multi-media contents supported by the respective delivery channels and platforms.

The advantage of using a PC platform over a traditional television platform is the ability to leverage the native support of IP connectivity, the breadth of software applications and the developer community working for PC applications. The PC platform provides also a gate to the infinite potential of the Web 2.0 to the television broadcasting industry. Thus, the television industry can fully control the delivery of its contents over the Internet.

A content management system is disclosed that comprises a computing system that includes an input component and an application component. The input component of the computing system receives digital television content of a broadcast network. The application component receives IP network content of an IP network. The application component then synchronizes the IP network content and the digital television content via DSM-CC stream events. The synchronization not only occurs at the client side, but it is also a closed loop with broadcasters and sponsors. Thus, the system implements e-commerce capability to digital television by leveraging the power of web applications and television broadcasting.

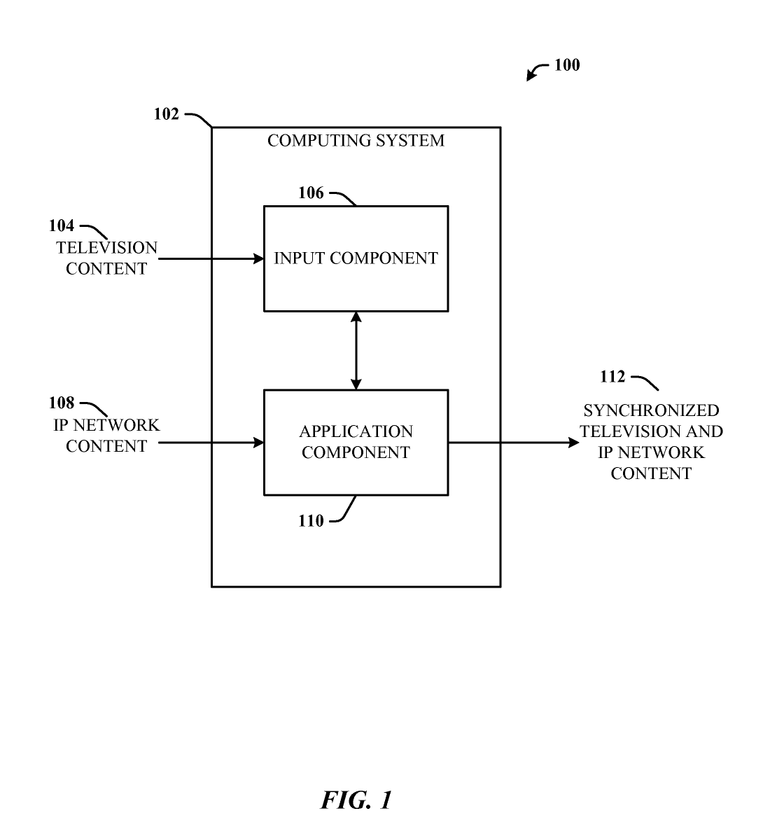

Referring initially to the drawings, FIG. 1 illustrates a content management system 100 that comprises a computing system 102 that includes an input component 106 and an application component 110. The input component 106 of the computing system 102 receives digital television content 104 of a broadcast network. The digital television content 104 includes broadcasted television programs, commercials, sports events, live events, news, or any other similar content media. The input component 106 communicates with the application component 110 to provide for content management of the broadcasted digital television content 104.

The application component 110 receives internet protocol (IP) network content 108 of an IP network. The IP network content 108 is any additional content media that is transmitted via an IP network, such as added programs, commercials, websites, etc. The application component 110 then synchronizes the IP network content 108 and the digital television content 104. The synchronized IP content and digital television content 112 is then utilized to deliver the additional content media and commercials tailored to specific groups of viewers based on demographics, geography and/or individual profiles (e.g., taste, preference, etc.).

The computing system 102 is any personal computer (PC), laptop, hand-held computing device, etc. equipped with a convergence platform, (e.g., Microsoft Vista Media Center) or a mobile phone equipped with digital TV reception (such as ISDB 1-segment in Japan) and IP network connectivity. The computing system 102 includes an application running on the PC or other device and receiving contents from the Internet. It is thus to be understood that any suitable multi-media applications are contemplated and intended to fall under the scope of the hereto-appended claims.

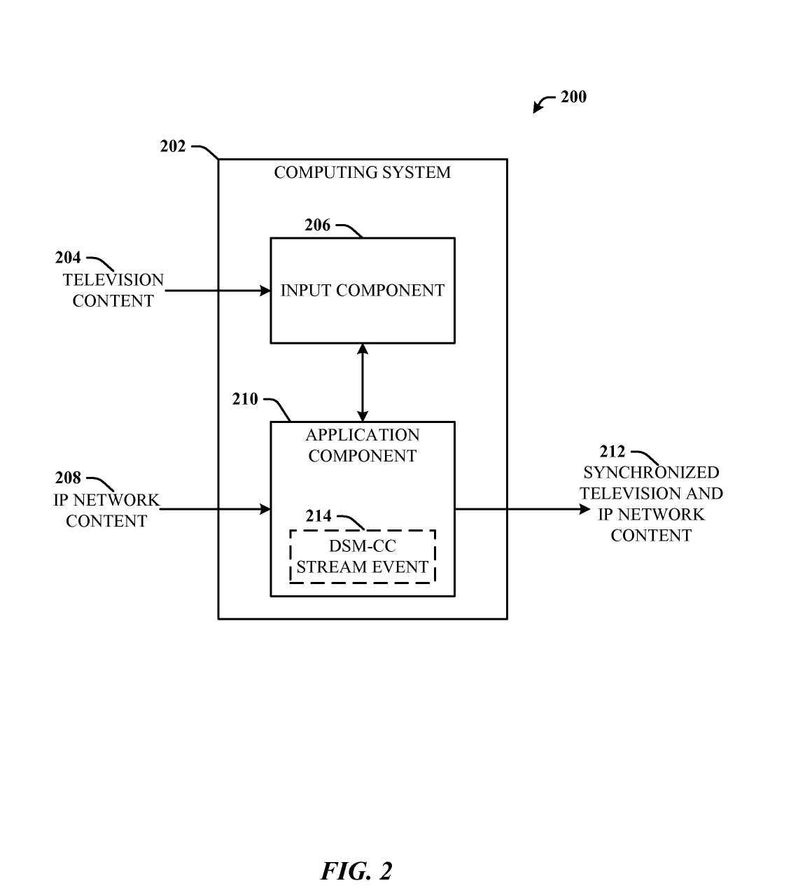

As illustrated in FIG. 2, a content management system 200 comprises a computing system 202 that includes an input component 206 and an application component 210. The input component 206 of the computing system 202 receives digital television content 204 of a broadcast network and communicates with the application component 210 to provide for content management of the broadcasted digital television content 204. The application component 210 receives IP network content 208 of an IP network and synchronizes the IP network content 208 and the digital television content 204.

Specifically, the application component 210 utilizes digital storage media command and control (DSM-CC) stream events 214 to synchronize the IP network content 208 and the digital television content 204. The DSM-CC stream events 214 are markers that are embedded in a transport stream via Moving Picture Experts Group (MPEG-2) private sections. Each marker comprises an event identifier and a time reference. The event identifier allows each stream event to be uniquely identified, the stream events are content media programs (e.g., commercial spots). Furthermore, the time reference indicates at what point in the stream the event should be triggered. Based on the event identifiers and the time reference, the broadcasted digital television content 204 can be synchronized with the IP network content 208. Thus, additional content media and commercials are delivered with the synchronized digital television content and IP network content 212.

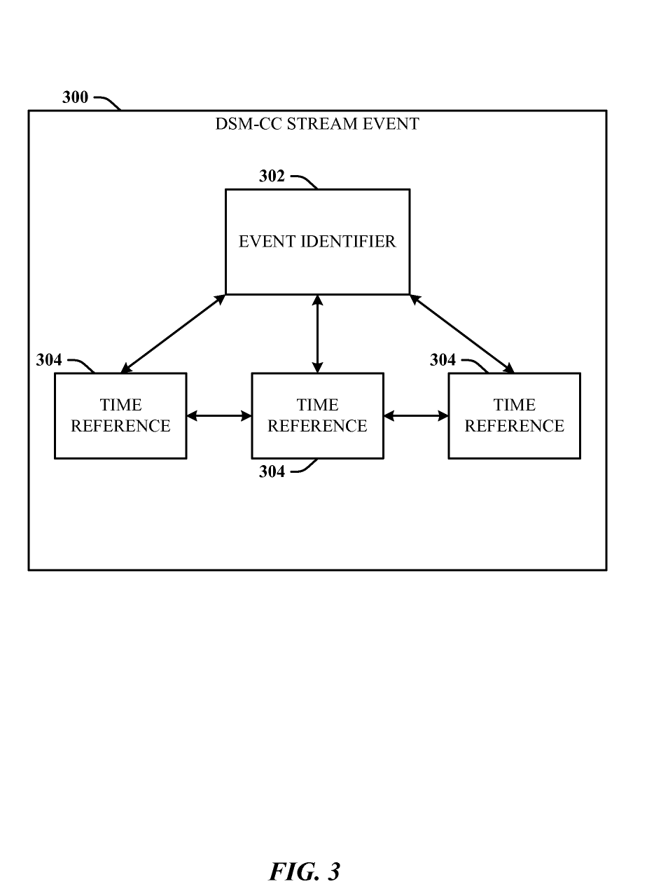

In more detail, FIG. 3 illustrates the DSM-CC stream event 300 used to synchronize the IP network content and the digital television content. As stated supra, the DSM-CC stream event 300 is a marker that is embedded in a transport stream via MPEG-2 private sections. The marker comprises an event identifier 302 and at least one time reference 304. The event identifier 302 allows each stream event to be uniquely identified, the stream events are content media programs (e.g., commercial spots, television programs, concerts, etc.). Furthermore, the at least one time reference 304 indicates at what point in the stream the event should be triggered. Additionally, multiple time references 304 can be used to assign firing at several times in the future. For example, several timing references 304 can be defined with a single DSM-CC stream event 300. This allows the sender to create multiple firing times referring to the same original broadcast event and allow broadcasters to schedule events on the viewer platform in advance.

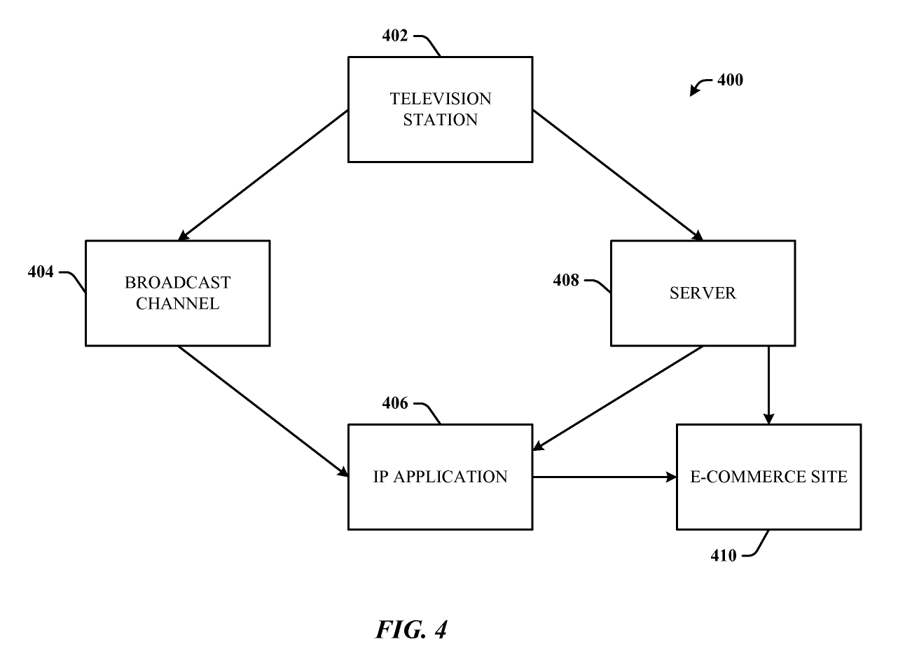

FIG. 4 illustrates operation of the content management system 400. In operation, the television station 402 broadcasts a digital television program along with metadata which is delivered over the broadcast channel 404 in the traditional manner. The television station 402 and the server 408 are linked, as such metadata such as stream event ID and program information is sent to the server 408 for delivery on the IP channel (client application). The server 408 can add content media such as commercial or additional contents and serve the IP application 406. On the client side, the broadcast of digital television content is fully synchronized with the IP channel via the broadcast channel 404, delivering additional content and commercials to the IP application 406. The digital television contents are synchronized via MPEG/DSM-CC stream events that provide an event identifier and a time reference that allows each stream event to be uniquely identified and indicates at what point in the stream the event should trigger. Once the digital television content and the additional IP content is synchronized, a viewer would be re-directed to a web service or e-commerce site 410 where the additional contents and commercials are viewed. Accordingly, the broadcasting entity and sponsors control the whole production and distribution process and share revenues, while leveraging the full potential of the additional IP delivery channel.

Specifically, the typical broadcast channel delivers contents to a wide region of users (one-to-many), while the IP channel is tailored to deliver contents in a one-to-one manner. The stream events can be delivered on the IP channel at different times and targeting specific groups of viewers based on demographics, geography or individual preference. A viewer can log-on to the IP application (e.g., media on-line portal) and fill out a questionnaire for demographic and background information, or a viewer can remain anonymous while on the IP media application. Information on user's preferences and profile can be inferred directly (automatically) from the viewing platform by monitoring the zip code or the genres of commonly viewed or recorded programs by the user.

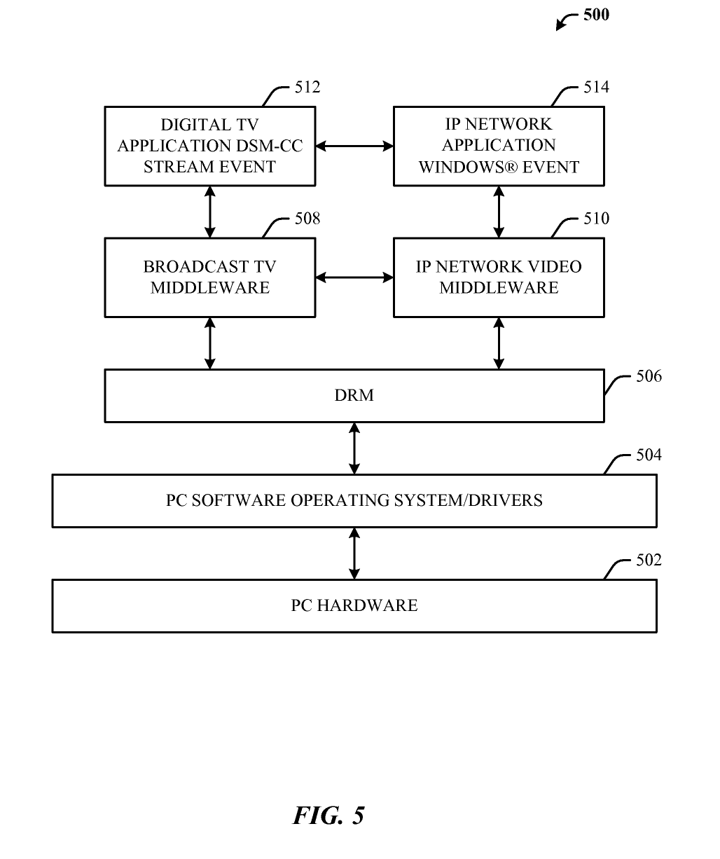

In more detail, FIG. 5 illustrates the synchronization mechanism 500 of the control management system. The synchronization mechanism 500 is built through Integrated Services Digital Broadcasting (ISDB) DSM-CC stream event protocol on one side and a Windows® Application on the other side, which monitors DSM-CC events and implements a mechanism to match metadata found in these events to relevant content delivered through an IP Network application. PC hardware 502 such as a tuner and Ethernet allow for connection to the broadcast network and to the Internet respectively. PC software 504, such as the operating system and drivers allow for interaction with the hardware devices 502. The PC software 504 constitutes an interface for communicating with the hardware devices 502. Protection of contents received from a broadcast is ensured by the platform which provides a proper Digital Rights Management (DRM) system 506. The DRM system 506 guarantees that no copyrighted contents are copied to a non-protected area of the computing system.

Broadcast TV middleware 508 and IP Network video middleware 510 is computer software that connects the Digital TV application DSM-CC stream event 512 and the IP Network application Windows® event 514. The middleware 508 and 510 typically contain ISDB stream decoder and presentation engine, Windows® Media streaming decoder and presentation engine and relevant metadata and playlist processing tools. Specifically, the connection between the Broadcast TV middleware 508 and the Windows® IP Network application 514 is implemented with a thin client/server. The thin client/server (not shown) monitors the stream events coming from the DSM-CC stream event 512 and matches the event ID to the corresponding object coming from the IP channel/network application 514. Due to the nature of the broadcast channel 512, the stream events sent through the DSM-CC 512 drive the timing, while the IP channel 514 provides a two-way communication and synchronization channel. Accordingly, the mechanism 500 provides a means to match events from broadcast and IP channels in a precise, timely manner.

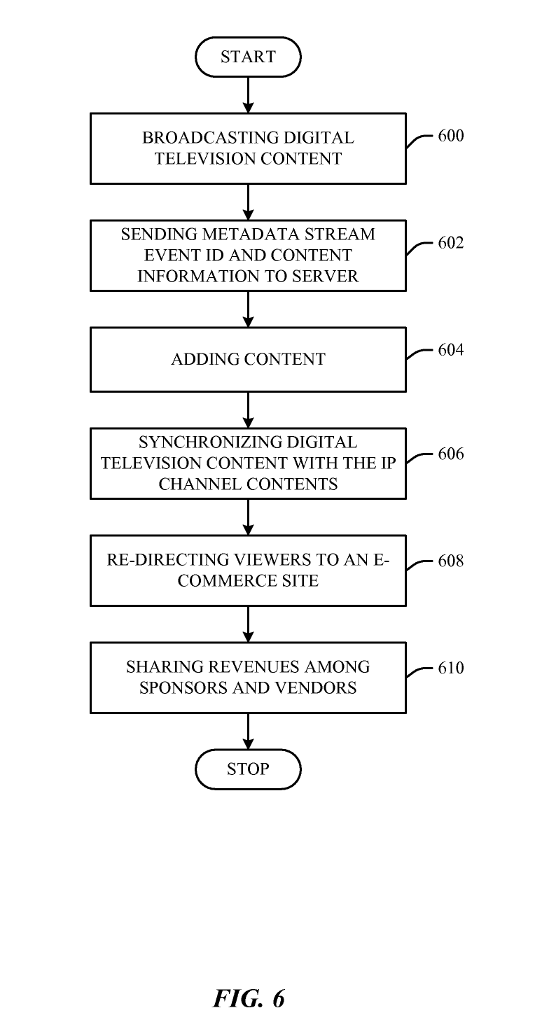

FIGS. 6-10 illustrate methodologies of synchronizing digital television content with IP network content, according to various aspects of the innovation. While, for purposes of simplicity of explanation, the one or more methodologies shown herein (e.g., in the form of a flow chart or flow diagram) are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring to FIG. 6, a method of synchronizing digital television content with IP network content is illustrated. At 600, digital television content is broadcasted over a broadcast channel. The digital television content includes broadcasted television programs, commercials, sports events, live events, news, or any other similar content media. At 602, metadata stream event ID and content information is sent to a server for delivery on an IP channel. Specifically, DSM-CC stream events sent for delivery on the broadcast channel match the metadata information sent to the server for IP delivery. The DSM-CC stream events are markers that are embedded in a transport stream via MPEG-2 private sections. Each marker comprises an event identifier and a time reference. The event identifier allows each stream event to be uniquely identified, and the time reference indicates at what point in the stream the event should be triggered.

At 604, content is added. The content is any additional content media that is transmitted via an IP network, such as added programs, commercials, websites, etc. And at 606, the broadcasted digital television content and the IP channel contents are synchronized to deliver the additional content and commercials. The digital television contents are synchronized via MPEG/DSM-CC stream events that provide an event identifier and a time reference that allows each stream event to be uniquely identified and indicates at what point in the stream the event should trigger. Based on this information, the IP channel can synchronize the digital television contents with the additional content. It is worth noting that while the delivery of contents on the broadcast channel is a “push” process, the delivery from the IP channel is a “pull” process triggered by the application based on DSM-CC stream events.

At 608, viewers are re-directed to an e-commerce site to view the additional content and commercials. Once the digital television content and the additional IP content is synchronized, a viewer would be re-directed to a web service or e-commerce site where the additional contents and commercials are viewed. And at 610, sponsors and vendors of the additional content and commercials share revenues. Accordingly, the broadcasting entity and sponsors control the whole production and distribution process and share revenues, while leveraging the full potential of the additional IP delivery channel. Revenues can also be calculated at stage 606 with the automatic delivery of added contents, based on user profile, without necessarily accessing an e-commerce site. In this case, the revenues are proportional to the number a specific commercial spot has been delivered.

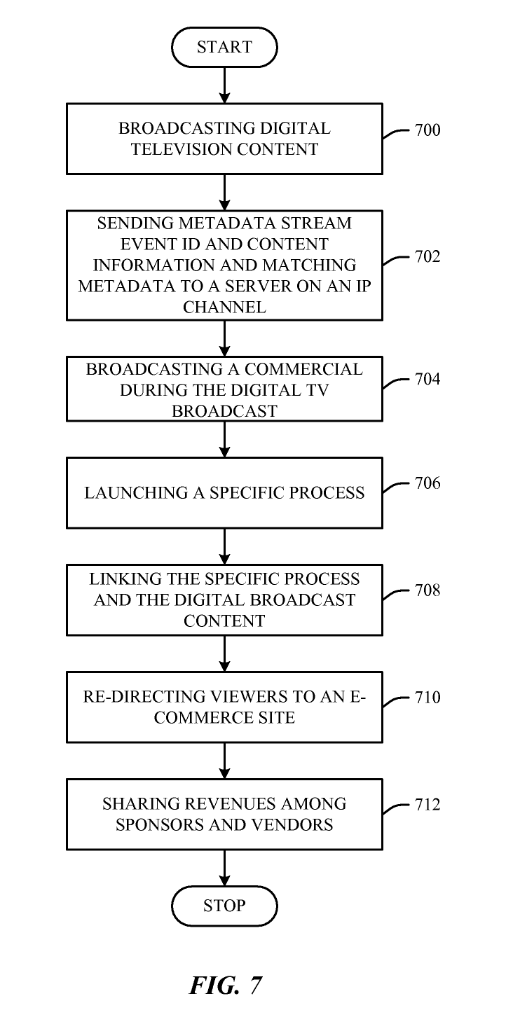

Referring to FIG. 7, a method of launching a specific process in relation with the broadcasted commercial content is illustrated. At 700, digital television content is broadcasted over a broadcast channel. At 702, metadata stream event ID and content information is sent over the DSM-CC channel for delivery on the broadcast channel and matching metadata to a server on an IP channel. At 704, a commercial is broadcasted during the digital television content broadcast. At 706, the metadata stream event is used to launch a specific process in relation with the broadcasted commercial. The specific process is any content media such as a web site, browser or other content related to the broadcasted commercial content. Furthermore, the DSM-CC stream events are markers that are embedded in a transport stream via MPEG-2 private sections. Each marker comprises an event identifier and a time reference. The event identifier allows each stream event to be uniquely identified, and the time reference indicates at what point in the stream the event should be triggered. Based on this information, the IP channel can synchronize the commercial contents with the specific process.

At 708, the specific process and the digital broadcast content are linked, allowing delivery of the specific process in a timely manner. At 710, viewers are re-directed to an e-commerce site to view the specific process. Once the digital television content and the specific process are synchronized, a viewer would be re-directed to a web service or e-commerce site where the specific process can be viewed. And at 712, sponsors and vendors of the specific process and broadcasted commercials share revenues. Accordingly, the broadcasting entity and sponsors control the whole production and distribution process and share revenues, while leveraging the full potential of the additional IP delivery channel.

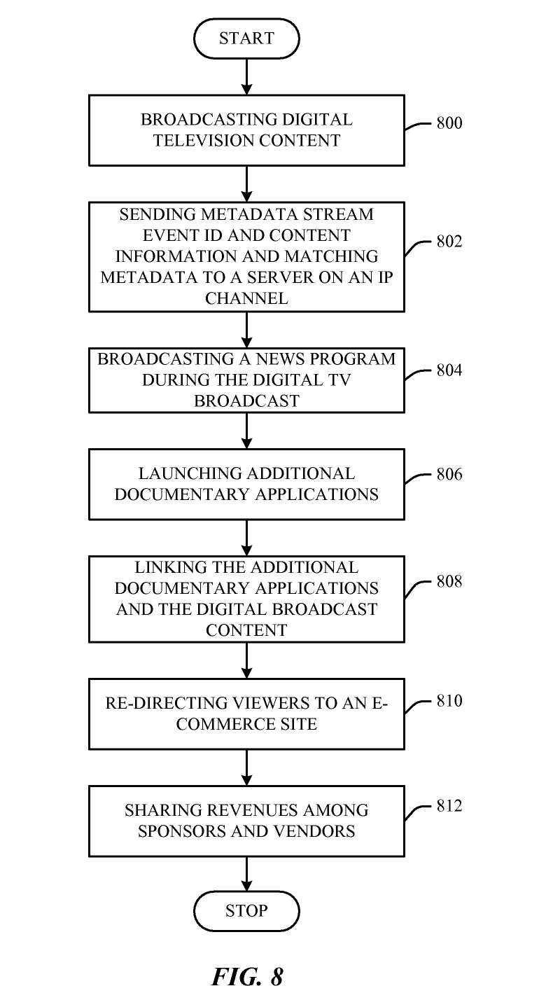

FIG. 8 illustrates a method of launching additional documentary applications in relation with the broadcasted news content. At 800, digital television content is broadcasted over a broadcast channel. At 802, metadata stream event ID and content information is sent over the DSM-CC channel for delivery on the broadcast channel and matching metadata to a server on an IP channel. At 804, a news program is broadcasted during the digital television content broadcast.

At 806, the metadata stream event is used to launch additional documentary applications in relation with the broadcasted news program. The additional documentary applications are any content media such as a web site, browser or other content related to the broadcasted news program content. For example, the additional documentary applications can be tailored to a viewer's interests. It would enhance the viewer watching experience by linking multi-media contents with linear news programs. Furthermore, the DSM-CC stream events are markers that are embedded in a transport stream via MPEG-2 private sections. Each marker comprises an event identifier and a time reference. The event identifier allows each stream event to be uniquely identified, and the time reference indicates at what point in the stream the event should be triggered. Based on this information, the IP channel can synchronize the news program contents with the additional documentary applications.

At 808, the additional documentary applications and the digital broadcast content are linked, allowing delivery of the additional documentary applications in a timely manner. At 810, viewers are re-directed to an e-commerce site or a browser is opened to view the additional documentary applications. Once the digital television content and the additional documentary applications are synchronized, a viewer would be re-directed to a web service, browser, or e-commerce site where the additional documentary applications can be viewed. And at 812, sponsors and vendors of the additional documentary applications and broadcasted news program share revenues. Accordingly, the broadcasting entity and sponsors control the whole production and distribution process and share revenues, while leveraging the full potential of the additional IP delivery channel.

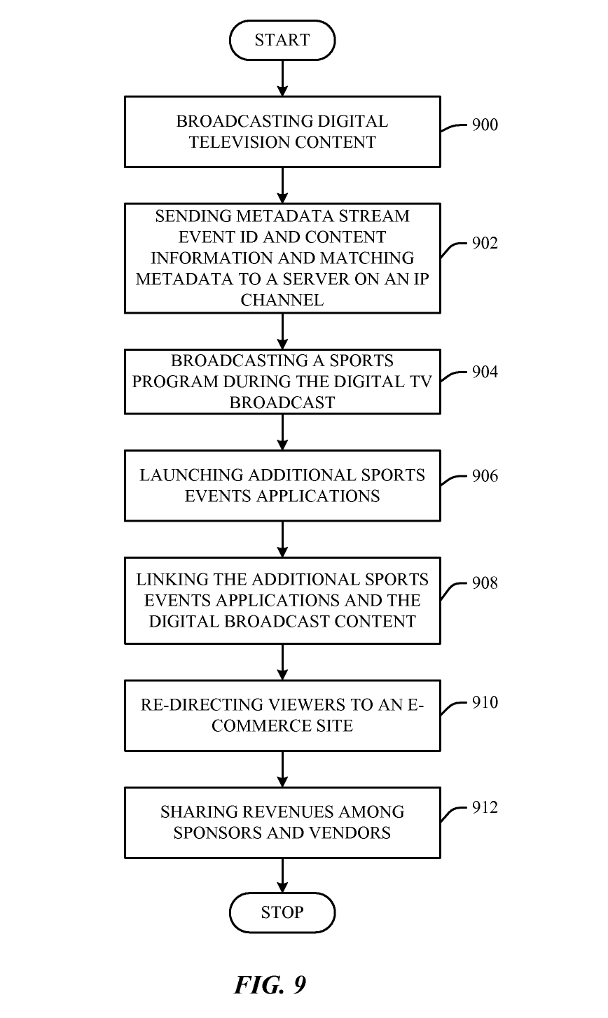

FIG. 9 illustrates a method of launching additional sports events applications in relation with the broadcasted sports program content. At 900, digital television content is broadcasted over a broadcast channel. At 902, metadata stream event ID and content information is sent over the DSM-CC channel for delivery on the broadcast channel and matching metadata to a server on an IP channel. At 904, a sports program is broadcasted during the digital television content broadcast.

At 906, the metadata stream event is used to launch additional sports events applications in relation with the broadcasted sports program. The additional sports events applications are any content media such as a web site, browser or other content related to the broadcasted sports program content. For example, the additional sports events applications can be tailored to a viewer's interests. It would enhance the viewer watching experience by linking multi-media contents with linear sports programs. Furthermore, the DSM-CC stream events are markers that are embedded in a transport stream via MPEG-2 private sections. Each marker comprises an event identifier and a time reference. The event identifier allows each stream event to be uniquely identified, and the time reference indicates at what point in the stream the event should be triggered. Based on this information, the IP channel can synchronize the sports program contents with the additional sports events applications.

At 908, the additional sports events applications and the digital broadcast content are linked, allowing delivery of the additional sports events applications in a timely manner. At 910, viewers are re-directed to an e-commerce site or a browser is opened to view the additional sports events applications. Once the digital television content and the additional sports events applications are synchronized, a viewer would be re-directed to a web service, browser, or e-commerce site where the additional sports events applications can be viewed. And at 912, sponsors and vendors of the additional sports events applications and broadcasted sports program share revenues. Accordingly, the broadcasting entity and sponsors control the whole production and distribution process and share revenues, while leveraging the full potential of the additional IP delivery channel.

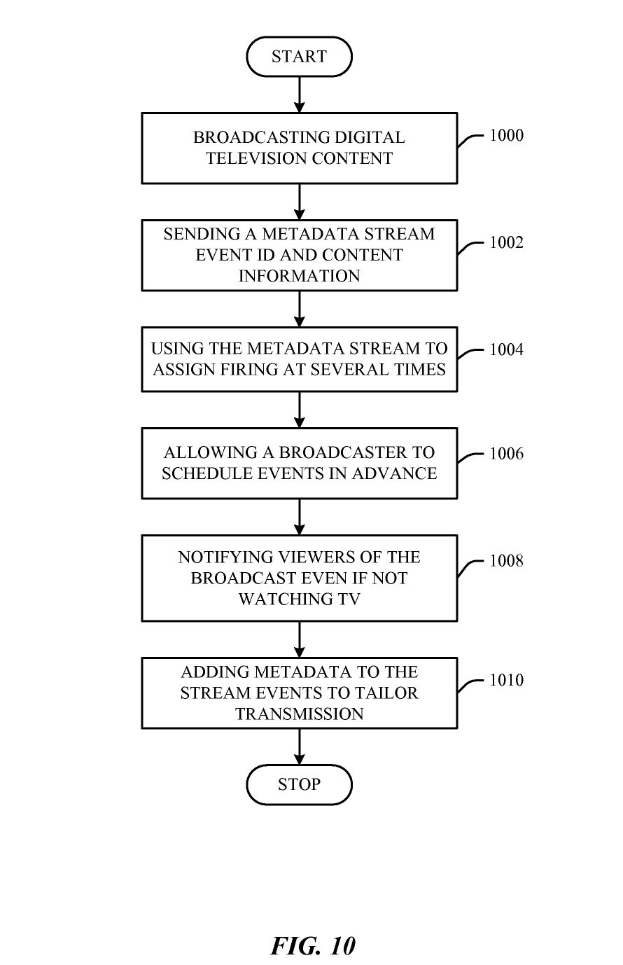

FIG. 10 illustrates a method of allowing a broadcaster to schedule events on a viewer platform in advance. At 1000, digital television content is broadcasted over a broadcast channel. At 1002, metadata stream event ID and content information is sent over the DSM-CC channel for delivery on an IP channel.

At 1004, the metadata stream event is used to assign firing at several times in the future. For example, several timing references can be defined with a single DSM-CC event ID. This allows the sender to create multiple firing times referring to the same original broadcast event. Furthermore, the DSM-CC stream events are markers that are embedded in a transport stream via MPEG-2 private sections. Each marker comprises an event identifier and at least one time reference. The event identifier allows each stream event to be uniquely identified, and the time reference indicates at what point or points in the stream the event should be triggered.

At 1006, broadcasters are allowed to schedule events on the viewer platform in advance. As stated supra, based on the timing references defined with the DSM-CC event ID, broadcasters can create multiple firing times referring to the same original broadcast event. At 1008, viewers are notified of the broadcast even if the viewers are not watching television at the particular time. Specifically media center edition (MCE) applications and/or electronic program guide (EPG) displays can be linked to the stream events such that a viewer enjoying services on the Media Center (Microsoft) that are not broadcasted TV programs could receive a pop-up or a change in icons or lay-out to invite the viewer to tune to the broadcast channel. For example, an icon could be dynamically linked to the broadcast. And at 1010, metadata is added to the stream events by broadcasters to tailor the transmission or re-transmission to certain timing and groups of viewers. Meta-data includes genre, demographics, geo-localization, user specific profiles, etc. For example, some major broadcasters provide re-transmission of their prime-time programs after a pre-defined time. This is used as a “catch-up” service for missed episodes, and is not meant to be a Video on Demand (VoD) service, but just a secondary channel for broadcast distribution. Accordingly, re-transmission can be tailored by broadcasters to certain timing and groups of viewers. For example, only entitled viewers could watch the re-transmission again on the platform with full resolution and copy to other devices, while other viewers would only have rights to watch the re-transmission at a lower quality.

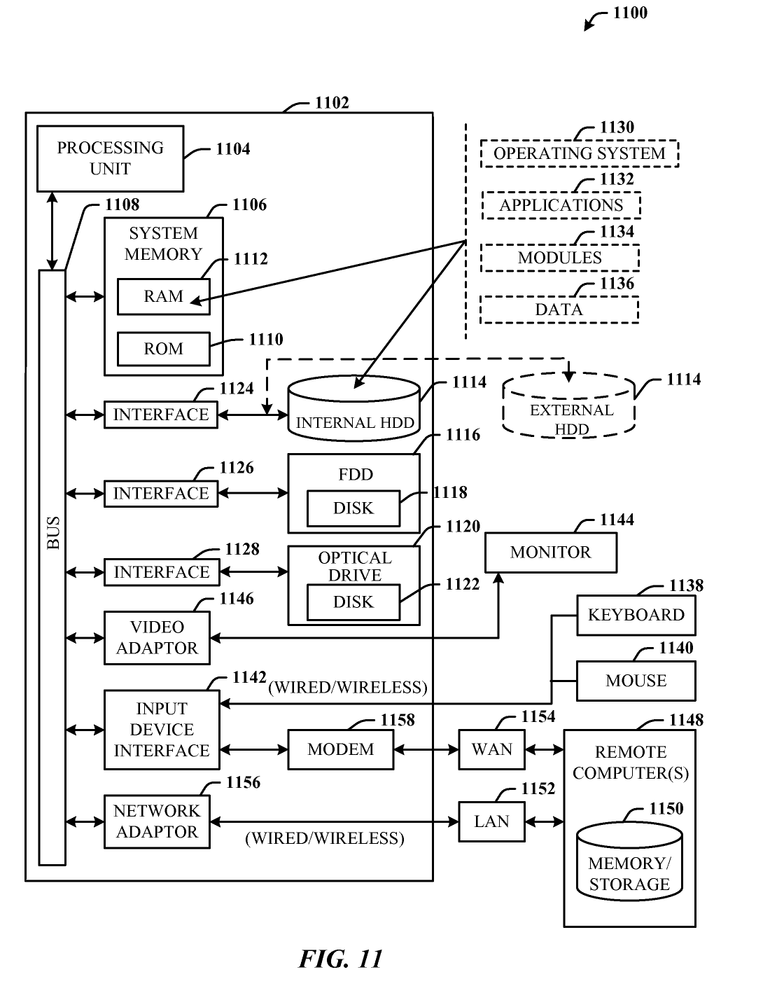

Referring now to FIG. 11, there is illustrated a block diagram of a computer operable to execute the disclosed synchronization architecture. In order to provide additional context for various aspects thereof, FIG. 11 and the following discussion are intended to provide a brief, general description of a suitable computing environment 1100 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the innovation can be implemented with various commercially available operating systems or combinations of operating systems.

A user can enter commands and information into the computer 1102 through one or more wired/wireless input devices (e.g., a keyboard 1138 and a pointing device, such as a mouse 1140). Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks (e.g., a wide area network (WAN) 1154). Such LAN and WAN networking environments are commonplace in offices and companies, and facilitate enterprise-wide computer networks, such as intranets, all of which may connect to a global communications network (e.g., the Internet).

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices (e.g., computers) to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

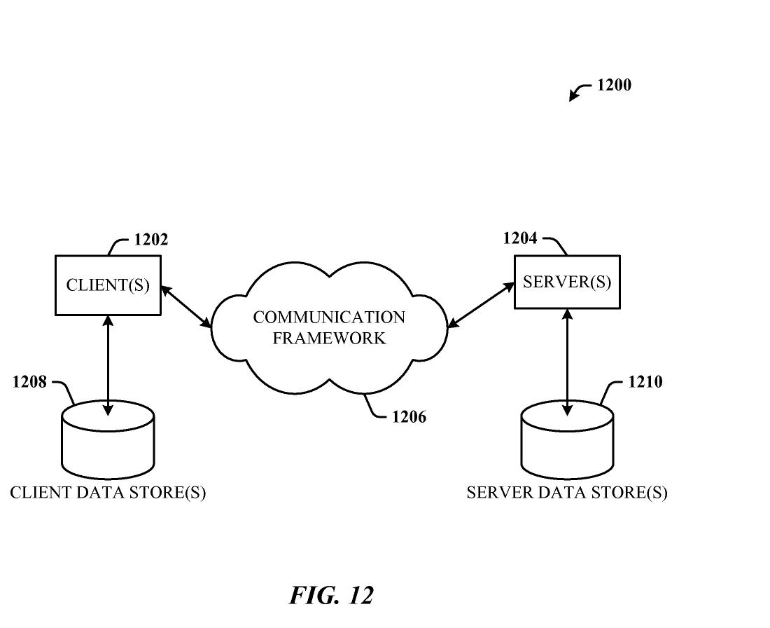

Referring now to FIG. 12, there is illustrated a schematic block diagram of an exemplary computing environment 1200 in accordance with another aspect. The system 1200 includes one or more client(s) 1202. The client(s) 1202 can be hardware and/or software (e.g., threads, processes, computing devices). The client(s) 1202 can house cookie(s) and/or associated contextual information by employing the subject innovation, for example.

The system 1200 also includes one or more server(s) 1204. The server(s) 1204 can also be hardware and/or software (e.g., threads, processes, computing devices). The servers 1204 can house threads to perform transformations by employing the invention, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for content management, comprising:
an input component of a computing system that receives digital television content of a broadcast network; and
an application component that receives IP content from an IP network and synchronizes the IP content to the television content.

2. The system of claim 1, wherein the application component utilizes digital storage media command and control (DSM-CC) stream events to synchronize the IP content and the television content.

3. The system of claim 2, wherein the DSM-CC stream events contain an event identifier and a time reference, the event identifier allows each stream event to be uniquely identified and the time reference indicates at what point in the stream the event should be triggered.

4. The system of claim 3, wherein the DSM-CC stream events are used to launch a specific process in relation with broadcasted commercial content.

5. The system of claim 3, wherein the DSM-CC stream events are used to launch additional documentary applications tailored to a viewer's interests based on a specific news program, sports program, drama program or cultural program.

6. The system of claim 2, wherein the DSM-CC stream events contain an event identifier and multiple time references, the multiple time references trigger events at several times in future.

7. The system of claim 2, wherein only a specific group of viewers are allowed to watch a re-transmission of the digital television content based on specific viewer characteristics.

8. The system of claim 7, wherein the viewer characteristics comprise at least one of viewer demographics, viewer geography, or individual viewer profiles.

9. The system of claim 1, wherein the computing system is equipped with a convergence platform.

10. The system of claim 1, wherein the digital television content comprises at least one of commercial spots, sports events, news stories, or live events.

11. A method of synchronizing digital television content with IP network content, comprising:
broadcasting digital television content over a broadcast channel;
sending metadata stream event ID and content information to a server for delivery on an IP channel;
adding content;
synchronizing the broadcasted digital television content with the IP channel contents to deliver the additional content;
re-directing viewers to an e-commerce site to view the additional content; and
sharing revenues among sponsors and vendors of the additional content.

12. The method of claim 11, further comprising utilizing DSM-CC stream events to synchronize the broadcasted digital television content with the IP channel contents.

13. The method of claim 12, wherein the DSM-CC stream event contain an event identifier and at least one time reference, the event identifier allows each stream event to be uniquely identified and the at least one time reference indicates at what point or points in the stream the event should be triggered.

14. The method of claim 11, further comprising:
broadcasting a commercial during the digital television content broadcast;
sending a metadata stream event and content information over the DSM-CC channel for delivery on an IP channel;
using the stream event to launch a specific process in relation with the broadcasted commercial; and
linking the specific process and the digital broadcast content in a timely manner.

15. The method of claim 11, further comprising:
broadcasting a news program during the digital television content broadcast;
sending a metadata stream event and content information over the DSM-CC channel for delivery on an IP channel;
using the stream event to launch additional documentary applications in relation with the broadcasted news program; and
linking the additional documentary applications and the digital broadcast content in a timely manner.

16. The method of claim 11, further comprising:
broadcasting a sports program during the digital television content broadcast;
sending a metadata stream event and content information over the DSM-CC channel for delivery on an IP channel;
using the stream event to launch additional sports events applications in relation with the broadcasted sports program; and
linking the additional sports events applications and the digital broadcast content in a timely manner.

17. The method of claim 11, further comprising:
broadcasting digital television content over a broadcast channel;
sending a metadata stream event identification and content information over the DSM-CC channel for delivery on an IP channel;
using the stream event to assign event firing at several times in the future; and
allowing a broadcaster to schedule events on the viewer platform in advance.

18. The method of claim 17, further comprising notifying viewers of the broadcast even if the viewers are not watching television on the IP channel at a particular time.

19. The method of claim 18, further comprising tailoring transmission of the broadcast to certain timing intervals or groups of users.

20. A system of synchronizing digital television content with IP network content, comprising:
means for broadcasting digital television content over a broadcast channel;
means for sending metadata stream event ID and content information to a server for delivery on an IP channel;
means for adding content;
means for synchronizing the broadcasted digital television content with the IP channel contents to deliver the additional content;
means for utilizing DSM-CC stream events to synchronize the IP channel contents and the broadcasted digital television content;
means for re-directing viewers to an e-commerce site to view the additional content; and
means for sharing revenues among sponsors and vendors of the additional content.
